(19) United States
(12) Patent Application Publication
(10) Pub. No.: US 2025/0233415 A1
(43) Pub. Date: Jul. 17, 2025

(54) ELECTRICAL PANEL LOAD CONTROL

(71) Applicant: Steffes, LLC, Dickinson, ND (US)

(72) Inventors: Thomas P. Steffes, Dickinson, ND (US); Paul J. Steffes, Dickinson, ND (US); Joshua P. Vetter, Dickinson, ND (US); Douglas Kadrmas, Dickinson, ND (US); Brent J. Kovash, Dickinson, ND (US)

(21) Appl. No.: 19/016,003

(22) Filed: Jan. 10, 2025

Related U.S. Application Data
(60) Provisional application No. 63/619,933, filed on Jan. 11, 2024.

(51) Int. Cl. H02J 3/14

(52) U.S. Cl. CPC H02J 3/14; H02J 2310/62

(57) ABSTRACT

In one embodiment of a method of controlling a level of consumption of electrical power distributed by an electrical panel using a load control device, electrical power supplied through the electrical panel is consumed using electrical devices. A current level of the electrical power is detected using a power meter. The detected level is compared to a load limit corresponding to a percentage of a maximum continuous electrical load rating for the electrical panel. When the detected current level is less than the load limit, increasing electrical power consumption by one or more flexible loads of the electrical devices to increase the current level using a controller of the load control device. When the detected current level is greater than or equal to the load limit, decreasing electrical power consumption by the one or more flexible loads to decrease the current level using the controller.

### CROSS REFERENCE TO RELATED APPLICATIONS

This application claims the benefit of priority from U.S. Provisional Patent Application No. 63/619,933 filed Jan. 11, 2024, entitled “Circuit Breaker Panel Load Control Device,” the content of which is hereby incorporated by reference.

### FIELD

Embodiments of the present disclosure generally relate to devices and methods for controlling an electrical load on an electrical service panel.

### BACKGROUND

Today the governmental and environmental community are strongly encouraging all buildings (including homes) to be all-electric by, for example, transitioning from gas or oil heating to fully electric heating, providing electric car charging services, etc.

The main electrical service panels (e.g., circuit breaker panels) of most buildings are considered undersized by existing regulations to handle a transition to all-electric. These buildings typically utilize electrical service panels having low-amperage capacities (e.g., 100 A panel rating) that are generally incapable of meeting the demands of an all-electric building, such as during peak demand periods. This problem may be solved by replacing the building's main electrical service panel to one that can meet the expected electrical demands.

However, such electrical service upgrades are very expensive not only for the building owner, but also the utility (electric power provider) due to the need to upgrade the local transformer and power line size to accommodate the increased power and energy demands.

### SUMMARY

Embodiments of the present disclosure relate to methods of controlling a level of consumption of electrical power distributed by an electrical panel, and a load control device for managing consumption of electrical power distributed by an electrical panel to electrical devices including one or more flexible loads.

In one embodiment of a method of controlling a level of consumption of electrical power distributed by an electrical panel using a load control device, electrical power supplied through the electrical panel is consumed using electrical devices. A current level of the electrical power is detected using a power meter. The detected level is compared to a load limit corresponding to a percentage of a maximum continuous electrical load rating for the electrical panel. When the detected current level is less than the load limit, increasing electrical power consumption by one or more flexible loads of the electrical devices to increase the current level using a controller of the load control device. When the detected current level is greater than or equal to the load limit, decreasing electrical power consumption by the one or more flexible loads to decrease the current level using the controller.

One embodiment of the load control device for managing consumption of electrical power distributed by electrical panel to electrical devices including one or more flexible loads includes a controller configured to compare a detected current level of electrical power supplied to an electrical panel to a load limit corresponding to a percentage of a maximum continuous electrical load rating for the electrical panel; communicate an instruction to increase electrical power consumption to at least one of the flexible loads when the detected level is less than the load limit; and communicate an instruction to decrease electrical power consumption to at least one of the flexible loads when the detected level is greater than or equal to the load limit.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of an electrical system of a building (commercial or residential) that includes an example of a load control device in use with an electrical service panel, in accordance with embodiments of the present disclosure.

FIG. 2 is a flowchart illustrating a method of controlling a level of consumption of electrical power supplied by an electrical panel using the load control device, in accordance with embodiments of the present disclosure.

FIG. 3 is a simplified diagram of an example use of relays to provide various device power connection configurations, in accordance with embodiments of the present disclosure.

FIG. 4 is a simplified diagram of an example controller, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

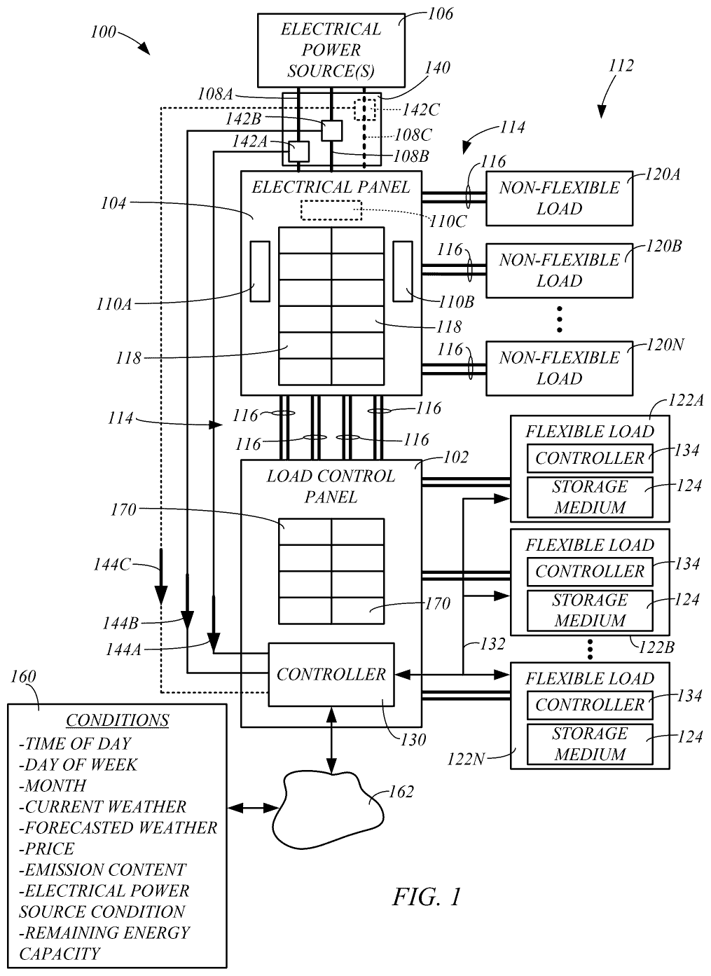

FIG. 1 is a simplified diagram of an electrical system 100 of a building (commercial or residential) that includes an example of a load control device 102 in use with an electrical service panel 104, in accordance with embodiments of the present disclosure. The load control device 102 is generally configured to improve the ability of a relatively low power residential or commercial building electrical service panel 104 to handle an increased electrical load without exceeding its maximum continuous electrical load panel rating, such as that issued by National Electrical Code. In general, the load control device 102 may be used to effectively increase a conventional electrical panel's electrical capacity (e.g., maximum daily kWh delivery) by utilizing a high percentage of the available electrical power supplied by one or more electrical power sources 106 throughout the day. Thus, the load control device 102 may allow the electrical panel 104 to handle an increased electrical load resulting from an increase in the number of electrical devices it serves, such as due to a change from gas or oil heating to electrical heating, higher electric car charging demands, and/or other changes that increase the electrical load on the service panel 104. Accordingly, the load control device 102 may be used to avoid the high cost of upgrading the electrical service panel 104 and corresponding wiring, as well as the utility components that serve them (e.g., distribution transformer, etc.).

The electrical service panel 104 may have a conventional form and receive electrical power from the one or more electrical power sources 106. The one or more electrical power sources 106 may include an electrical grid, a renewable energy source (e.g., solar panels, wind turbines, etc.) and/or another source of electrical power. The electrical power may be supplied through multiple power lines 108 in accordance with a conventional arrangements. Thus, the electrical power may be supplied in two phases through lines 108A and 108B, in three phases, such as through lines 108A, 108B and line 108C (phantom line), for example.

Each of the power lines 108 is connected to a corresponding power phase 110 of the panel 104. The electrical panel distributes the electrical power to a plurality of electrical devices 112 through power outputs 114. The power outputs 114 of the panel 104 may each comprise a wire pair 116, in which one wire is connected to one of the power phases 110 and the other wire is connected to a different one of the power phases 110 or to a neutral phase 110 of the panel 104 to set the desired voltage of the power output, for example. A circuit breaker 118 may be positioned between the phases 110 and the power outputs 114, in accordance with conventional arrangements.

The electrical devices 112 may include one or more non-flexible loads 120, such as non-flexible loads 120A-N, and one or more flexible loads 122, such as flexible loads 122A-N, for example. The non-flexible loads 120 generally relate to electrical devices 112 that are triggered to consume electrical power for immediate use, such as lights, cooking devices (e.g., ovens, microwaves, etc.), fans, entertainment devices, and other electrical devices.

The flexible loads 122 generally relate to electrical devices 112 that may be operated on a time-shifted schedule while meeting the demands of the building or users. Examples of such flexible loads 122 include heating devices such as space heaters, baseboard heaters, water heaters, heat pumps, hot tub heaters, etc., electrical cooling devices such as air conditioners, refrigerators, freezers, etc., battery chargers including electrical vehicle chargers, and other electrical devices 112. Accordingly, some flexible loads 122 convert the electrical power into a different energy form, such as thermal energy, chemical energy, etc.

In some embodiments, some of the flexible loads 122 may include an energy storage medium 124, in which the converted energy generated by the flexible loads 122 may be stored for later (time-shifted) use. When the flexible load 122 is in the form of a heating or cooling device, the flexible load 122 may include a thermal storage medium 124 for storing hot or cold thermal energy, such as a liquid medium (e.g., water) or a solid medium (e.g., brick, stone, metal block, etc.). When the flexible load 122 is in the form of a battery charger, the energy storage medium 124 may include a chemical storage medium of the battery, in which chemical energy can be stored.

The energy storage mediums 124 allow the flexible loads 122 to periodically consume electrical power without an immediate need for the power, such as during off-peak demand periods, and store the converted form of the electrical power in the energy storage medium 124. When the stored electrical power is needed at a later time, such as when the flexible load 122 is not consuming electrical power (e.g., during peak demand periods), the flexible load 122 may utilize the stored energy in the medium 124 to provide a desired service (e.g., heating, cooling, powering, etc.). Examples of a heating device flexible load 122 include the Steffes Electric Thermal Storage (ETS) heaters, which convert electrical power into heat that may be stored in a thermal storage medium and used to heat a single room or an entire home or building, such as during periods when the heaters are not consuming electrical power.

The load control device 102 includes a controller 130 that is configured to control the operation of the flexible loads 122 and their power consumption on an individual or group basis, such as through the issuance of control signals 132 to controllers 134 of the flexible loads 122 through a wired or wireless communication link and in accordance with a conventional communication protocol (e.g., CTA-2045 (ECOPORT)). The controller 130 may activate one or more of the flexible loads 122 to consume electrical power, deactivate one or more of the flexible loads 122 to terminate power consumption, and/or adjust a level of power consumption by the one or more flexible loads 122, to provide a desired electrical load on the panel 104.

Each flexible load controller 134 may communicate various information to the controller 130 of the device 102, which may use the information to determine the manner in which the flexible load 122 should be used to consume electrical power. The load information may include a current level of power consumption by the flexible load 122, which may be obtained using a power meter of the flexible load, such as a current and/or voltage meter, for example. When the flexible load 122 includes an energy storage medium 124, the flexible load controller 134 may communicate a remaining energy capacity of the energy storage medium 124 that indicates the amount of electrical power the flexible load 122 may consume before it must be deactivated.

In some embodiments, the load control device 102 includes a power meter 140 that is configured to sense the electrical power being delivered from the power source 106 and distributed by the electrical panel 104. The power meter 140 may take on any suitable form. For example, the power meter 140 may include a current sensor (e.g., current meters) and/or a voltage sensor for each of the power lines 108 and phases 110 to monitor the electrical power through each of the phases 110. For example, the power meter 140 may include current sensors 142A-C that are configured to produce sensor outputs 144A-C that are indicative of a level (i.e., magnitude) of the current being conducted through the corresponding phases 110A-C. The sensor outputs 142 may be communicated to the controller 130 through a suitable wired or wireless communication link. Alternatively, the power meter 140 may comprise an existing power meter of the building or the electrical panel 104.

In some embodiments, the controller 130 monitors the electrical power distributed by the electrical panel 104 using the sensor outputs 142 and controls the power consumption by the flexible loads 122 to drive consumption of the supplied electrical power up to a predetermined level (e.g., percentage) of the electrical service panel rating to take advantage of a remaining unused capacity of the panel 104. For example, without the load control device 102, during certain periods the actual electrical power demands of a building may be 20% of the rating of the electrical panel 104, leaving 80% of the panel's capacity being unused.

The controller 130 of the device 102 can take advantage of the remaining capacity of the panel 104 by selectively activating or increasing the power consumption of one or more of the flexible loads 122 to increase the total power distributed by the panel 104, such as up to a load limit, such as a predetermined level of the panel rating. Examples of the load limit include about 25-85% of the panel rating, about 75-85% of the panel rating, about 80% of the panel rating, or another percentage of the panel rating. Thus, in the example where the building has actual electrical power demands of 20% of the panel rating, the controller 130 may selectively activate one or more of the flexible loads 122 to consume additional electrical power (e.g., 60% of the panel rating) to increase the supplied power to a higher level that is at or below the load limit (e.g., 80% of the panel rating), for example. Accordingly, the load control device 102 can control the flexible loads 122 to maintain a high level of electrical power consumption by the electrical devices 112, even when the actual immediate demand or needs of the building would be met by a lower level of electrical power consumption by the devices 112.

In some embodiments, the controller 130 performs the flexible load control operation continuously and/or during various periods throughout the day, such as during off-peak energy consuming hours and/or when there is excess renewable energy available for consumption, for example. The controller 130 may also be used to control the use of the energy stored in the energy storage mediums 124 to ensure that the demands of the building (e.g., heating and/or cooling) are met during periods when there is a desire to consume a lower level of the electrical power from the electrical power source 106, such as due to high demand or high pricing for example.

As a result, the load control device 102 may allow buildings and utilities to avoid having to upgrade electrical panels, main building supply wires, distribution transformers, etc., while maximizing the energy consumption capability of the home or building. For example, without the load control device 102, a building service panel rated at 100-amps, may face demands from the various electrical devices 112 at certain times that exceed its 100-amp capacity, triggering a breaker 118 and preventing the desired operation of the electrical devices 112. The load control device 102 avoids this problem through the controlled electrical consumption and optional storage of the electrical power throughout the day. For example, the load control device 102 could control the flexible loads 122 to consume and store the electrical power up to the load limit, such as 80% (80-amps) of the panel rating throughout the day resulting in electrical power consumption of 460 kWh per day. During periods when the non-flexible loads 120 demand a high level of the electrical power, the energy consumption of one or more of the flexible loads 122 may be reduced or deactivated to maintain the electrical power distributed by the panel 104 at a level that is at or below the panel rating, thereby avoiding the triggering of a breaker 118 and allowing the panel to fully meet the electrical demands of the building.

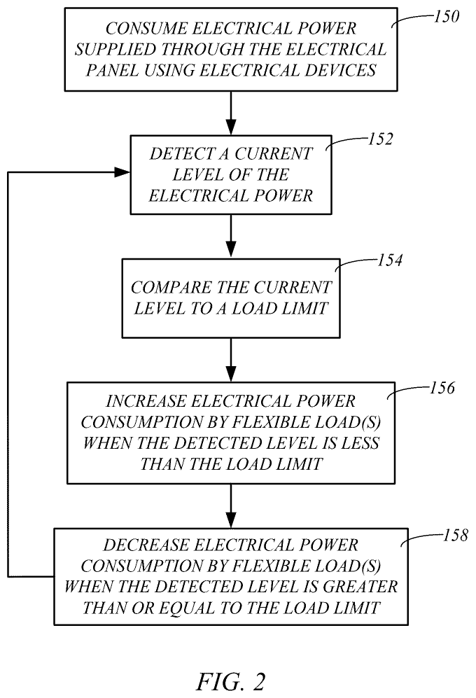

FIG. 2 is a flowchart illustrating a method of controlling a level of consumption of electrical power supplied by an electrical panel 104 using the load control device 102, in accordance with embodiments of the present disclosure. At 150, the electrical power supplied through the electrical panel 104 is consumed using the electrical devices 112. That is, the electrical power supplied through the power outputs 114 may be consumed by one or more of the non-flexible loads 120 and/or one or more of the flexible loads 122. At 152, the controller 130 detects a current level of the electrical power, such as a total power or total current being distributed by the panel 104, using the power meter 140, such as using the sensor outputs 144 from the current sensors 142. The controller 130 compares the current level to the load limit at 154. When the current level is less than the load limit, the controller 130 controls one or more of the flexible loads 122 to increase their electrical power consumption, as indicated at 156. When the current level is greater than or equal to the load limit, the controller 130 controls one or more of the flexible loads 122 to decrease their electrical power consumption, as indicated at 158. Steps 152, 154, 156 and 158 may be repeated a limited number of times to provide the desired load control for the panel 104.

The controller 130 may use various conditions or information (hereinafter “conditions”) 160 (FIG. 1) to control the electrical power consumption by the flexible loads 122 in steps 156 and 158, and/or to adjust the load limit, which may have the effect of increasing or decreasing power consumption by the flexible loads 122. Some of the conditions 160 may be obtained through communications with the flexible loads 122. Additional conditions 160 may be obtained from other information resources using conventional data communications techniques, such as data communications through a network 162 (e.g., Internet), cellular communications, etc. Examples of the conditions 160 include the remaining energy capacity of the flexible loads 122, a time of day, a day of the week, a month, current and/or forecasted weather conditions (e.g., temperature, wind velocity, humidity), a price of the electrical power supplied by the source, an electrical power source condition, emission content information relating to a carbon level associated with the supplied electrical power, and other conditions, as indicated in FIG. 1.

As mentioned above, the flexible loads 122 may communicate their energy consumption status, remaining energy capacity and other information to the controller through a suitable communication link. These conditions or information may be used to control the energy consumption of the flexible loads 122. For example, when electrical power consumption by one or more flexible loads 122 is to be increased (step 156), the controller 130 may direct the flexible loads 122 having a higher remaining energy capacity to consume more electrical power than the flexible loads 122 having a lower remaining energy capacity. Likewise, when electrical power consumption by one or more flexible loads 122 is to be decreased (step 158), the controller 130 may direct the flexible loads 122 having a lower remaining energy capacity to consume less electrical power than the flexible loads having a higher remaining energy capacity. The controller 130 may also increase the load limit when the remaining energy capacity of the flexible loads 122 is relatively high and decrease the load limit when the remaining energy capacity of the flexible loads is relatively low.

The controller 130 may also control the flexible loads 122 and/or adjust the load limit based on the time of day, day of the week, month and/or price conditions 160. For example, during high energy demand periods, the controller may avoid consuming energy using the flexible loads 122, and during low energy demand periods, the controller 130 may direct the flexible loads 122 to consume electrical power.

The controller 130 may also control the flexible loads 122, such as heating or cooling devices, based on the time of the year (e.g., month) and/or current or future weather conditions 160. For example, during certain winter or summer periods, or when the weather indicates current or future periods of cold or hot temperatures, the controller 130 may direct the heating or cooling devices to consume a greater amount of electrical power and store a greater amount of thermal energy to ensure that the demands of the building are met, and/or increase the load limit. Likewise, the controller 130 may decrease electrical power consumption and thermal energy storage by the heating or cooling devices 122 and/or lower the load limit, when the time of year or the weather conditions indicate a lower demand for heating or cooling operations.

The condition of the power source 106 may include a communication from the power source (e.g., electrical grid) indicating a desire for increased or decreased power consumption. The controller 130 may react to the communication by increasing or decreasing the power consumption of the flexible loads 122 and/or increasing or decreasing the load limit.

When the power source is a renewable energy source (e.g., solar panel, wind turbine, etc.), the power source condition may indicate a level of electrical power that is being generated. Thus, when the indicated level of renewable energy generation is high, the controller 130 may increase the power consumption by the flexible loads 122 and/or increase the load limit, and when the indicated level is low, the controller 130 may decrease the power consumption by the flexible loads 122 and/or decrease the load limit.

The emission content information may be obtained from a website, database, or other source and generally indicates a carbon level associated with the electrical power supplied by the power source 106. Energy generated through the burning of fossil fuels is associated with a high carbon level, whereas energy generated using renewable energy sources has a low carbon level. This allows the controller 130 to increase the power consumption by the flexible loads 122 and/or increase the load limit when the emission content information indicates that the supplied electrical power has a lower associated carbon level, and decrease the power consumption by the flexible loads 122 and/or decrease the load limit when the emission content information indicates that the supplied electrical power has a higher carbon level.

The method of FIG. 2 and the features described herein using the load control device 102 may allow a building to significantly increase its electrical power consumption while using a relatively low-power electrical service panel 104 and the existing building wiring. Furthermore, increases in the electrical power consumption of the building may be met using the existing components of the electrical power source 106 that supply the power (e.g., distribution transformer, etc.). As a result, the load control device 102 can be used to accommodate a building transition to a more electric configuration by eliminating the need to make costly upgrades to the building electrical service panel 104 and the electrical distribution components of the power source 106.

In some embodiments, the controller 130 operates to balance the electrical power being delivered through the power phases 110 of the electrical panel 104, such as when one of the power phases is supplying a greater level of current to the electrical devices 112 than the other power phases 110. In one embodiment, the load control device 102 includes a plurality of relays 170 (FIG. 1) that may be controlled by the controller 130 to adjust the power phase or phases 110 that are used to supply the electrical power to one or more of the electrical devices 112, such a flexible load 120 or a non-flexible load 122 connected to the device 102. The relays 170 may take on any suitable form, such as a mechanical relay or a solid state relay.

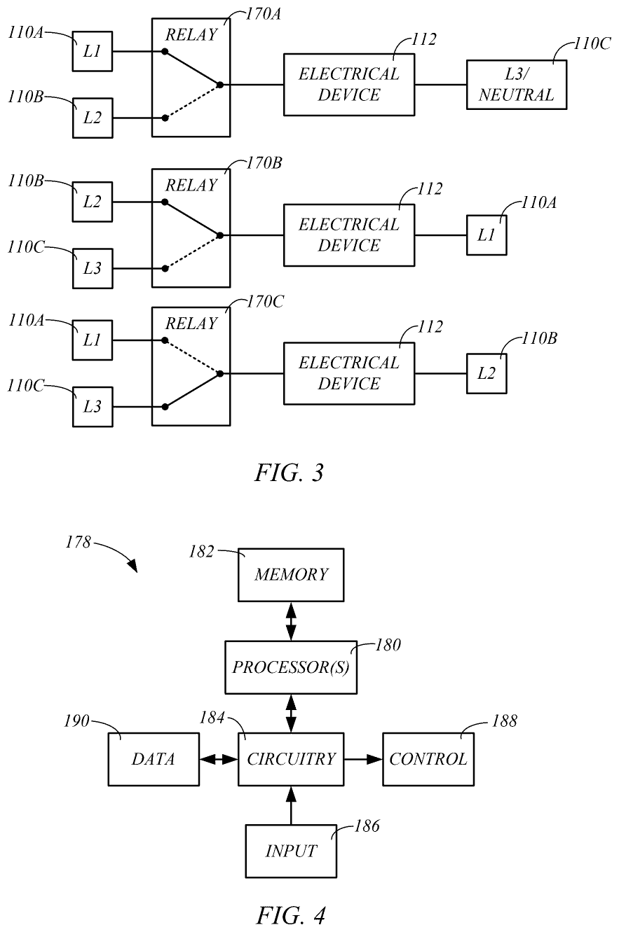

FIG. 3 is a simplified diagram of an example use of the relays 170 to provide various connection configurations with the power phases 110 of the electrical panel 104, in accordance with embodiments of the present disclosure. The one or more relays 170 are connected to the power outlets 114 of the electrical panel 104 and may connect an electrical device 112 to a desired one of the phases 110 or neither of the phases 110 in response to a control signal from the controller 130. In the example shown in FIG. 3, a relay 170A may be used to selectively connect an electrical device 112 in series between the phase 110C, which may be a power phase or a neutral phase, and one of the phases 110A or 110B, or neither of the phases 110A and 110B; a relay 170B may be used to selectively connect an electrical device 112 in series between the phase 110A, which may be a power phase or a neutral phase, and one of the phases 110B or 110C or neither of the phases 110B and 110C; and a relay 170C may be used to selectively connect an electrical device 112 in series between the phase 110B, which may be a power phase or a neutral phase, and one of the phases 110A or 110C or neither of the phases 110A and 110C.

During the detecting step 152 (FIG. 2), the controller 130 monitors the level of current in each of the power phases 110 using the sensor outputs 144 from the current sensors 142. The controller 130 uses the relays 170 to selectively connect one or more of the electrical devices 112 that are consuming electrical power from a power phase 110 conducting a high level of current to a power phase 110 conducting a lower level of current to balance the currents in the phases 110. For example, when the current level in the power phase 110A is higher than the current level in the power phase 110B, the controller 130 may use the relay 170A (FIG. 3) to disconnect the electrical device 112 from the power phase 110A and connect the electrical device 112 to the power phase 110B (phantom line). This reduces the current being conducted through the power phase 110A and increases the current being conducted through the power phase 110B, makes the currents in the phases 110 more balanced, and prevents overloading of a phase 110 of the electrical panel 104.

The controller 130 of the load control device 102 and the controller 134 of the flexible loads 122 may take on any suitable form. An example of a suitable controller 178 that may be used to form the controller 130 or the controller 134 is shown in the simplified diagram of FIG. 4. The controller 178 may include one or more processors 180 and memory 182, which may be local memory or memory that is accessible to the controller 178. The one or more processors 180 are configured to perform various functions described herein in response to the execution of instructions contained in the memory 182, for example.

The one or more processors 180 may be components of one or more computer-based systems, and may include one or more control circuits, microprocessor-based engine control systems, and/or one or more programmable hardware components, such as a field programmable gate array (FPGA). The memory 182 represents any suitable patent subject matter eligible computer-readable media and does not include transitory waves or signals. Examples of the memory 182 include conventional data storage devices, such as hard disks, CD-ROMs, optical storage devices, magnetic storage devices and/or other suitable data storage devices or computer-readable media.

The controller 178 may include circuitry 184 for use by the one or more processors 180 to receive input signals 186 (e.g., sensor outputs, conditions, data communications), issue control signals 188 (e.g., control signals 132) and/or communicate data 190, such as in response to the execution of the instructions stored in the memory 182 by the one or more processors 180.

Although the embodiments of the present disclosure have been described with reference to preferred embodiments, workers skilled in the art will recognize that changes may be made in form and detail without departing from the spirit and scope of the present disclosure.

What is claimed is:

1. A method of controlling a level of consumption of electrical power distributed by an electrical panel using a load control device, the method comprising:
i) consuming the electrical power supplied through the electrical panel using electrical devices;
ii) detecting a current level of the electrical power using a power meter;
iii) comparing the detected level to a load limit corresponding to a percentage of a maximum continuous electrical load rating for the electrical panel;
iv) when the detected current level is less than the load limit, increasing electrical power consumption by one or more flexible loads of the electrical devices to increase the current level using a controller of the load control device;
v) when the detected current level is greater than or equal to the load limit, decreasing electrical power consumption by the one or more flexible loads to decrease the current level using the controller; and
repeating ii-v a limited number of times.

2. The method according to claim 1, wherein the one or more flexible loads are selected from the group consisting of a thermal device, a heating device, a cooling device and a battery charger.

3. The method according to claim 1, wherein:
the one or more flexible loads each include an energy storage medium; and
consuming the electrical power comprises converting the electrical power into a form that is stored in an energy storage medium using the one or more flexible loads.

4. The method according to claim 3, wherein:
the one or more flexible loads include a thermal device configured to convert the electrical power into hot or cold heat energy and store the heat energy in its energy storage medium; and
the energy storage medium includes a liquid or a solid.

5. The method according to claim 4, wherein the thermal device is selected from the group consisting of a water heater, a space heater, a hot tub heater, a heat pump, a baseboard heater and an air conditioner.

6. The method according to claim 5, further comprising releasing the stored heat energy.

7. The method according to claim 1, wherein increasing electrical power consumption by one or more of the flexible loads comprises transitioning at least one of the flexible loads from a deactivated state to an activated state and/or adjusting the electrical power consumption by at least one of the flexible loads from a lower level of electrical power consumption to a higher level of electrical power consumption.

8. The method according to claim 7, wherein increasing electrical power consumption by one or more of the flexible loads comprises increasing the electrical power consumption by at least one of the flexible loads until the current level reaches the load limit.

9. The method according to claim 7, wherein increasing electrical power consumption by at least one of the flexible loads comprises increasing the electrical power consumption by at least one of the flexible loads in response to a communication from the controller to the at least one of the flexible loads.

10. The method according to claim 7, wherein decreasing electrical power consumption by one or more of the flexible loads comprises deactivating at least one of the flexible loads and/or adjusting the electrical power consumption by at least one of the flexible loads from a higher level of electrical power consumption to a lower level of electrical power consumption.

11. The method according to claim 10, wherein decreasing electrical power consumption by one or more of the flexible loads comprises decreasing the electrical power consumption by at least one of the flexible loads until the current level reaches the load limit or drops below the load limit.

12. The method according to claim 10, wherein decreasing electrical power consumption by at least one of the flexible loads comprises decreasing the electrical power consumption by at least one of the flexible loads in response to a communication from the controller to the at least one of the flexible loads.

13. The method according to claim 1, wherein the load limit is selected from the group consisting of about 25-85% of the panel rating, about 75-85% of the panel rating and about 80% of the panel rating.

14. The method according to claim 1, wherein, the method includes:
obtaining one or more conditions using the controller; and
adjusting the load limit based on the one or more conditions using the controller.

15. The method according to claim 14, wherein the conditions comprise a time of day, a day of the week, a month of the year, a current weather condition, a forecasted weather condition, a price of available electrical power, or emission content information on available electrical power.

16. The method according to claim 14, wherein the conditions comprise a remaining energy capacity of the one or more flexible loads.

17. The method according to claim 14, wherein:
electrical power is supplied to the electrical panel by an electrical power source; and
the conditions include a condition of the electrical power source.

18. The method according to claim 1, wherein:
consuming electrical power comprises consuming electrical power that is conducted through at least two power phases of the electrical panel using the electrical devices;
detecting the current level of the electrical power using the power meter comprises detecting a current level in each of the power phases using a corresponding current sensor of the power meter, each current sensor having a sensor output that is indicative of the detected current level
the load control device includes one or more relays; and
the method includes changing the power phases through which electrical power is conducted to one or more of the electrical devices using the one or more relays based on at least one of the sensor outputs using the controller.

19. The method according to claim 18, wherein:
the power phases include a first power phase and a second power phase;
the one or more electrical devices include a first electrical device connected in series with a third phase, which is a neutral phase or a power phase;
the one or more relays include a first relay configured to selectively connect the first power phase or the second power phase to the first electrical device; and
changing the phases through which electrical power is delivered to one or more of the flexible loads using the one or more relays based on at least one of the sensor outputs using the controller comprises:
connecting the first electrical device in series between the first power phase and the third phase using the first relay;
consuming electrical power conducted through the first power phase and the third phase using the first electrical device;
adjusting the first relay using the controller to connect the first electrical device in series between the second power phase and the third phase; and
consuming electrical power conducted through the second power phase and the third phase using the first electrical device.

20. A load control device for managing consumption of electrical power distributed by an electrical panel to electrical devices including one or more flexible loads, the load control device comprising a controller configured to:
compare a detected current level of the electrical power to a load limit corresponding to a percentage of a maximum continuous electrical load rating for the electrical panel;
communicate an instruction to increase electrical power consumption to at least one of the flexible loads when the detected level is less than the load limit; and
communicate an instruction to decrease electrical power consumption to at least one of the flexible loads when the detected level is greater than or equal to the load limit.

21. The load control device according to claim 20, wherein the load control device includes a power meter that detects the current level of electrical power supplied to the electrical panel.

22. The load control device according to claim 20, wherein, the controller is configured to:
obtain one or more conditions; and
adjust the load limit based on the one or more conditions.

23. The load control device according to claim 22, wherein the conditions comprise a time of day, a day of the week, a month of the year, a current weather condition, a forecasted weather condition, a price of available electrical power, or emission content information on available electrical power.

24. The load control device according to claim 22, wherein the conditions comprise a remaining energy capacity of the one or more flexible loads.

25. The load control device according to claim 22, wherein:
electrical power is supplied to the electrical panel by an electrical power source; and
the conditions include a condition of the electrical power source.

26. The load control device according to claim 20, wherein:
the electrical power is conducted through at least two power phases of the electrical panel;
the load control device includes one or more relays that are each configured to selectively connect any one of the power phases to a corresponding one of the electrical devices; and
the controller is configured to change the power phases through which electrical power is conducted to the one or more electrical devices using the corresponding relay based on a level of current through the power phases.

27. The load control device according to claim 26, wherein:
the power phases include a first power phase and a second power phase;
the electrical devices include a first electrical device connected in series with a third phase, which is a neutral phase or a power phase;
the one or more relays include a first relay configured to selectively connect the first power phase or the second power phase to the first electrical device; and
the controller is configured to selectively connect the first electrical device in series with the third phase and any one of the first power phase and the second power phase using the first relay.
